(19) United States
(12) Patent Application Publication
(10) Pub. No.: US 2026/0245258 A1
(43) Pub. Date: Aug. 20, 2026

(54) INFORMATION PROCESSING APPARATUS, IMAGE COMPRESSION METHOD, AND IMAGE RESTORATION METHOD

(71) Applicant: CANON KABUSHIKI KAISHA, Tokyo (JP)

(72) Inventor: Hayato OURA, Tokyo (JP)

(21) Appl. No.: 19/535,184

(22) Filed: Feb. 10, 2026

(30) Foreign Application Priority Data
Feb. 19, 2025 (JP) 2025-025225

(51) Int. Cl. G06T 9/00; G06V 10/25

(52) U.S. Cl. CPC G06T 9/002; G06V 10/25

(57) ABSTRACT

An information processing apparatus is provided. The information processing apparatus determines, from input image data, a first area that is not a target of image compression processing and image restoration processing by machine learning, executes first compression processing of compressing image data without machine learning, executes second compression processing of compressing image data with machine learning, and compresses an area including the first area in the input image data by the first compression processing, and compressing a remaining area by the second compression processing.

### BACKGROUND

### Field of the Technology

The technology of the present disclosure relates to an information processing apparatus, an image compression method, and an image restoration method.

### Description of the Related Art

In recent years, a technology using a machine learning method represented by a neural network or the like is utilized in various fields. In particular, technology development using a convolutional neural network (CNN) using data such as an image as input data has been actively conducted. In the operation processing using the neural network, in particular, the utilization of the technology using the CNN is advancing in the field of image processing. Application destinations of image processing of the CNN include image data compression and restoration. After being subjected to compression processing by the CNN, the image is input to another CNN that achieves data restoration of the output result thereof, and a restored image is acquired, thereby achieving image compression and restoration. This technology is being studied as one of measures against an increase in data amount due to an increase in resolution of still images and an increase in resolution and frame rate of moving images. On the other hand, a further high compression method for the entire image utilizing a known image compression algorithm is also studied. Such studies include one that controls the strength of data compression depending on an image area in an image and achieves high compression (see Japanese Patent Laid-Open No. 2021-057769).

The configuration of the known technology described above specifies an area to be targeted in an image, and controls the strength (degree) of data compression depending on the area. However, in a case where the compression rate of the entire image is increased, there is a possibility that the compression rate of an area other than the focused area is so high that the image is collapsed. On the other hand, it is generally known that a result of higher compression and better subjective image quality than a known image compression algorithm can be obtained in a case where the CNN processing is utilized for image compression and restoration.

However, it is also known that when compression and restoration by the CNN are performed in a case where a person’s face, a character string, a geometric pattern, and the like are included in an image, an artifact specific to CNN processing occurs in the image after restoration, and the subjective image quality deteriorates, which is a problem. Therefore, in the compression and restoration processing using the CNN, it is necessary to take measures for a difficult area for the CNN in which an artifact specific to the CNN processing is likely to occur in the image.

### SUMMARY

By controlling an image area that is a target of image compression and restoration of an image using a machine learning model, the technology of the present disclosure achieves both improvement in compression rate and suppression of deterioration of image quality due to compression.

According to one aspect of the present disclosure, an information processing apparatus comprising: at least one memory storing instructions; and at least one processor that is in communication with the at least one memory and that, when executing the instructions, cooperates with the at least one memory to execute processing, the processing including determining, from input image data, a first area that is not a target of image compression processing and image restoration processing by machine learning, executing first compression processing of compressing image data without machine learning, executing second compression processing of compressing image data with machine learning, and compressing an area including the first area in the input image data by the first compression processing, and compressing a remaining area by the second compression processing is provided.

According to the above configuration, by controlling an image area that is a target of image compression and restoration of an image using a machine learning model, it is possible to achieve both improvement in compression rate and suppression of deterioration of image quality due to compression.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram illustrating an image processing apparatus according to the present embodiment.

FIG. 1B is a schematic diagram of processing of image compression, restoration, and area determination using a CNN.

FIG. 1C is a schematic diagram of learning for area determination using the CNN. FIG. 2A is a view illustrating an example of input image data according to the present embodiment.

FIG. 2B is a view illustrating a relationship between input image data and a CNN processing non-target area according to the present embodiment.

FIG. 3 is a flowchart showing compression processing of input image data according to a first embodiment.

FIG. 4 is a flowchart showing restoration processing of input image data according to the first embodiment.

FIG. 5 is a view illustrating a difficult area according to a second embodiment. FIG. 6 is a flowchart showing generation processing of supervisory data of difficult area detection processing according to the second embodiment.

FIG. 7 is a view illustrating a state in which an area other than a difficult area according to a third embodiment is processed.

FIG. 8 is a flowchart showing processing of input image data according to the third embodiment.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Configuration of Image Processing Apparatus 10

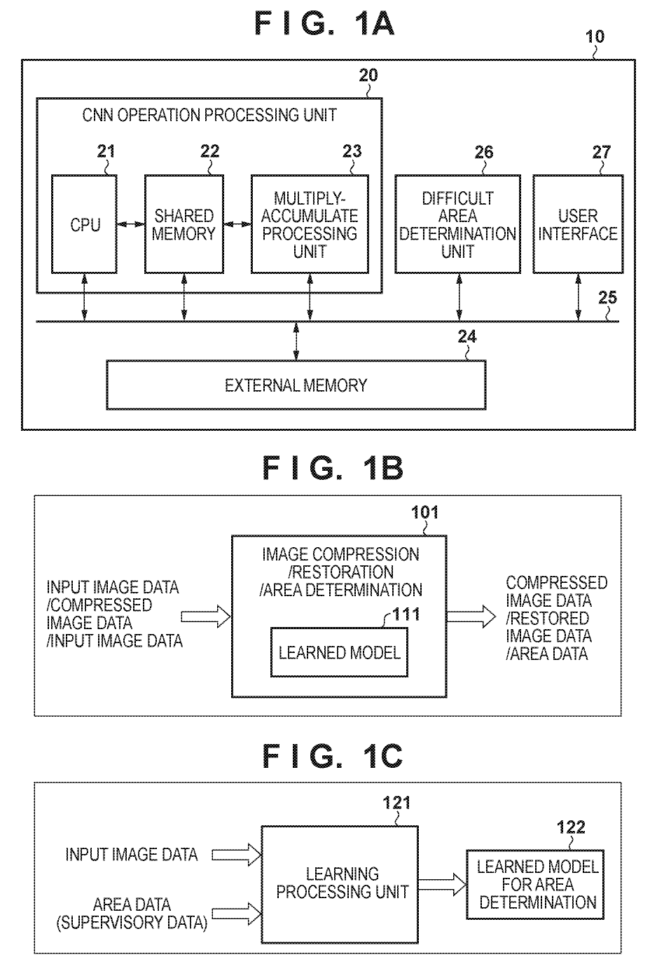

FIG. 1A is a block diagram illustrating an image processing apparatus 10. As illustrated in FIG. 1A, the image processing apparatus 10 includes a convolutional neural network (CNN) operation processing unit 20, an external memory 24, an internal bus 25, a difficult area determination unit 26, and a user interface 27. The CNN operation processing unit 20 includes a central processing unit (CPU) 21, a shared memory 22, and a multiply-accumulate processing unit 23. The CPU 21 is a control unit that controls the operation of the image processing apparatus 10, and other processing units operate in response to an instruction from the CPU 21. Note that the CPU 21 needs not be included in the CNN operation processing unit 20. Alternatively, the image processing apparatus 10 may include a CPU different from the CPU 21.

The external memory 24 is generally a memory having a lower speed and a larger capacity than the shared memory 22. The external memory 24 is a memory that stores input image data that is a data compression target that is a processing target in the CNN operation processing unit 20, tile data cut out from the input image data in units of tiles to be subjected to CNN processing, data after the end of the processing, and model parameter of the CNN. The internal bus 25 performs mutual connection with the CPU 21, the shared memory 22, the multiply-accumulate processing unit 23, the external memory 24, the difficult area determination unit 26, and the user interface 27, and performs data communication based on a predetermined communication protocol. The multiply-accumulate processing unit 23 is a central processing unit of the CNN operation, and repeatedly performs a multiply-accumulate (e.g., convolution operation) of the CNN. The shared memory 22 is a memory that can store tile data that is input data of the CNN operation, an operation result, parameters of a model used for the multiply-accumulate, and the like. It is accessible from the CPU 21, the multiply-accumulate processing unit 23, and the internal bus 25.

The difficult area determination unit 26 determines an area in the image to be a non-target of the image compression processing by the CNN operation processing unit 20 for the input image data stored in the external memory 24 or the shared memory 22. Note that the difficult area determination unit 26 may be included in the CNN operation processing unit 20, and the processing in the difficult area determination unit 26 described above may be performed by the CPU 21 or the multiply-accumulate processing unit 23. That is, the difficult area determination unit 26 may achieve area determination of a difficult area by area determination processing using a learned model of machine learning by the CNN or the like. In that case, the entire input image data corresponding to one image is a target of processing by the CNN operation processing unit 20. The difficult area determination unit 26 may specify the difficult area by executing an area determination algorithm that does not use machine learning. The user interface 27 stores, into the external memory 24 or the shared memory 22, various setting values set by the user of the image processing apparatus 10, and the CPU 21 or the like reads them as setting values.

Note that the image processing apparatus 10 may be, for example, a general-purpose computer or an image processing unit built in a camera or the like. For example, in a case of an image processing unit built in a camera, a processing target image is an image captured by the optical system of the camera, and the image may be compressed by the image processing apparatus 10, stored in the external memory 24, and restored at the time of reading. Alternatively, it may be transmitted to another apparatus in a compressed form as is. In that case, it is desirable that the learned model, the optimized filter, or the like to be used for restoration processing is shared between the image processing apparatus 10 and equipment of the transmission destination of the compressed image data.

The CNN operation processing unit 20, in particular, the multiply-accumulate processing unit 23 may be, for example, a dedicated hardware circuit such as an application specific integrated circuit (ASIC) designed to achieve a specific function. Alternatively, the multiply-accumulate processing unit 23 may have a configuration in which a specific function is achieved by a processor such as a digital signal processor (DSP) or a graphics processing unit (GPU) executing software. The multiply-accumulate processing unit 23 outputs processed image data to the shared memory 22, the external memory 24, or the like.

Hereinafter, description will be given with a case where input image data or tile data stored in the external memory 24 or the shared memory 22 is a processing target in the image processing apparatus 10.

### Overview of Compression by CNN

The convolutional neural network (CNN) is a method of machine learning and is a neural network using convolution. The CNN itself is a known technology and is used for image processing and the like. For example, for image compression, compression is performed by a convolution layer of the CNN, and restoration of a compressed image is performed by a fully connected layer or a transposed convolution layer. In the convolution layer, for example, a local feature such as an edge or a pattern is extracted by a convolution operation of a filter (kernel) with input image data, and it is stored as encoded compressed image data. In the transposed convolution layer, a filter is applied to the compressed image data to restore the image. For example, in a case where the restoration is performed in the transposed convolution layer, the weight of the machine learning model of each of the compression and the restoration is learned by, for example, back propagation or the like, using, as a loss function, an error between the original image and the restored image in which the original image is compressed and restored. The CNN operation processing unit 20 can perform multiply-accumulate with the image data using a learned model to perform image compression and/or image restoration. The learned model may be stored in the external memory 24, for example, and loaded into a shared memory and used when image compression or image restoration is performed.

The CNN can also be applied to area determination of an image. The CNN to be used for area determination is constituted by a convolution layer, a pooling layer, a fully connected layer, and the like, and learning is performed using, as a loss function, an error between an area determination result using a learning model, for example, and correct answer data of the area determination. By the area determination, for example, an area label indicating whether or not a pixel is a difficult area for each pixel is output as an area determination result.

Note that learning of the learning model to be used for image compression and restoration and learning of the learning model to be used for determination of a difficult area may be performed by the image processing apparatus 10 or may be performed by another apparatus. In the latter case, the image processing apparatus 10 may perform compression, restoration, and area determination by acquiring the generated learned model.

FIG. 1B is a schematic diagram of processing of image compression, restoration, and area determination using the CNN. Here, all the processing by a processing unit 101 is achieved by the CNN operation processing unit 20, and therefore three types of processing are illustrated in one diagram, but these processes may be achieved by different machine learning models. First, regarding the image compression processing, input is image data constituted by pixels, for example, and the image compression is performed by the processing unit 101 using a learned model 111 of the image compression processing to output compressed image data. Regarding the restoration processing of the compressed image, input is, for example, compressed image data, and the image data restored by performing the restoration processing by the processing unit 101 using the learned model 111 of the image restoration processing is output. For example, as illustrated in FIG. 1C, the learning for compression and restoration may be performed using, as a loss function, a difference between restored image data restored by compressing original image data with the original image data as input data and the original image data. Use of a learned model obtained as a result of learning with such learning data achieves compression and restoration of image data. Note that the area detection processing of the difficult area will be described in the following sections of Definition of Difficult Area and Determination Method for Difficult Area.

### Definition of Difficult Area

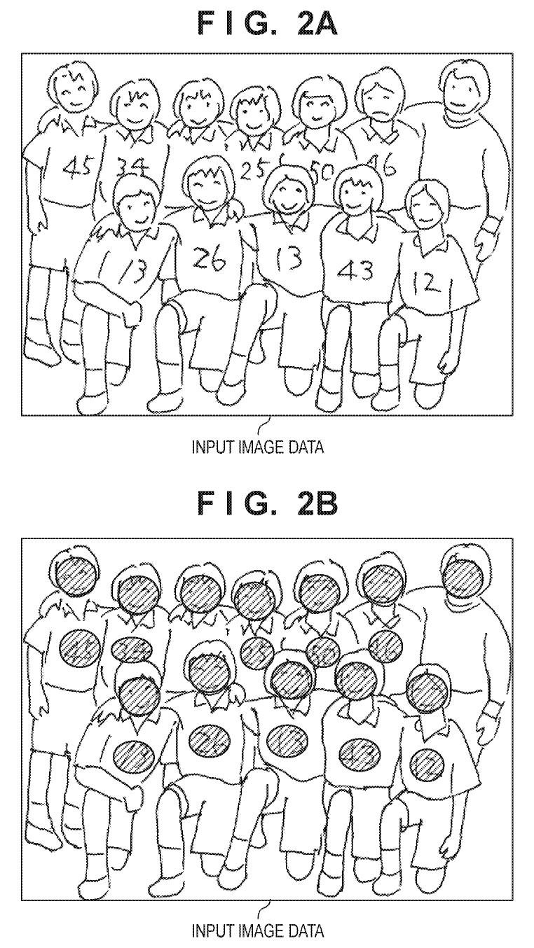

FIG. 2A is a view illustrating an example of input image data to be subjected to determination processing by the difficult area determination unit 26. In contrast to FIG. 2A, the hatched area surrounded by circle frames in FIG. 2B indicates an area to be a non-target of the processing of the image generation neural network that performs image restoration. In general, image compression and restoration processing using a neural network have a known disadvantage that deterioration of an image restoration result is easily recognized at a portion such as a person’s face, a character string, or a geometric pattern, and subjective image quality is poor. Therefore, the difficult area determination unit 26 determines a portion of a person’s face, a character string, or a geometric pattern as a difficult area, and achieves making such a portion a non-target of processing of the image generation neural network that performs image restoration. Note that the example of the difficult area that is not the target of the CNN processing illustrated in FIG. 2B is an example, and the scope of the claims is not limited to this. Thus, the difficult area is an area in which the degree of deterioration of the image quality is great by image compression processing and image restoration processing by machine learning, and refers to an area that is not a target of the image compression processing and the image restoration processing by the machine learning.

### Determination Method for Difficult Area

The difficult area is specified by calculation by an area determination neural network or by an area determination algorithm. The area determination neural network is achieved by performing learning so as to determine the difficult area and other areas. For example, the area determination neural network, that is, the learned model of the difficult area determination is obtained by performing learning so as to determine the difficult area using, as the correct answer data, the area data in which the difficult area is labeled as "1" and the other area is labeled as "0" with respect to the input image data. Alternatively, a feature may be extracted from the input image data without using machine learning, pattern recognition of at least one of a person’s face, a character string, and a geometric pattern may be performed based on the feature, and the recognized pattern or an area including the pattern may be determined as a difficult area.

FIG. 1C is a schematic diagram of machine learning, in the present example, learning for area determination using the CNN. The input image data and area data indicating the difficult area and the other areas corresponding to the input image data are input to a learning processing unit 121 as learning data. The learning processing unit 121 performs area determination using a learning model, and adjusts a parameter (weight or the like) of the learning model using a difference between the result thereof and supervisory data as an error function to obtain a learned model 122. The learned model 122 is used as the learned model 111 for the area determination processing illustrated in FIG. 1B. Labeling of the area of the supervisory data may be performed by a human user. Learning of the area determination processing may be performed using the area data labeled in this manner as correct answer data. In a case where this learning is performed by the image processing apparatus 10, the learning processing unit 121 is achieved by executing a learning program by the CNN operation processing unit 20.

Note that values used at the time of learning of the difficult area and the other area are examples, and the scope of the claims is not limited to these. In this manner, inference by the learned area determination neural network is performed, and the difficult area determination unit 26 performs determination of the difficult area.

On the other hand, the area determination algorithm uses edge detection, template matching, a sliding window method, or a cascade classifier. These are methods generally used when detecting a person’s face, a character string, a geometric pattern, or the like. These methods specify the difficult area, and achieve discrimination from the other area. The difficult area determination unit 26 performs determination processing using the area determination neural network or the area determination algorithm, to perform the area determination of the difficult area as illustrated in FIG. 2B. The hatched area in FIG. 2B is the area determined to be a difficult area, and the non-hatched area is the other area, that is, the area not determined to be the difficult area.

### Processing of Difficult Area and Other Area

As described above, the difficult area determination unit 26 performs area determination of the difficult area and the other area of the input image data. The multiply-accumulate processing unit 23 of the CNN operation processing unit 20 performs compression processing on the area determined to be the other area in the input image data. At this time, the CNN model, which is a data compression neural network to be input to the multiply-accumulate processing unit 23, will be a learned model in which learning of data compression has been sufficiently performed in advance. The input image data is divided into tiles so as to match the input tile size of the CNN model that achieves this data compression, and the input tile data is created. In a case where the input tile data is constituted by the other area without including the difficult area, the multiply-accumulate processing unit 23 performs compression processing. The output format of the CNN model that achieves data compression is data in which the other area that is the input image data is encoded into a latent space by multiply-accumulate processing. Alternatively, it may be a character string that is called a prompt and serves as an instruction to cause the image generation neural network that performs image restoration to execute a task. In this manner, in a case where the input tile data in the input image data does not include the difficult area that is not suitable for compression processing by the CNN and is constituted only by the other area, the multiply-accumulate processing unit 23 achieves data compression.

On the other hand, in a case where the input tile data includes a difficult area, the CPU 21 executes the image compression algorithm by operation processing and performs image compression processing without using the learned model by machine learning. The image compression algorithm to be performed by the CPU 21 may be lossless compression or lossy compression not based on machine learning. The lossless compression includes run-length encoding and Huffman encoding, and the lossy compression includes discrete cosine transform or fractal compression. Note that the image compression processing is not limited to these examples. The processing is not limited to that in the CPU 21, and in a case where there is an image compression processing circuit, the image compression may be achieved by the corresponding circuit.

In this manner, the compressed image data divided into tiles and compressed by any method in units of tiles may be stored together with, for example, a compression method for each tile and arrangement information indicating arrangement of the tiles. At the time of restoration, restoration is performed using a method according to the compression method. For example, a tile compressed by using the CNN is restored by restoration processing using a learned model for restoration corresponding to the learned model used for compression. On the other hand, a tile compressed by an image compression algorithm not based on machine learning is restored by executing a decoding algorithm corresponding to the compression algorithm. The tile thus restored is rearranged according to the arrangement information thereof, and the entire image is restored. Note that when the compression processing is performed in units of tiles, an overlapping area may be provided between tiles. By providing the overlapping area, the edge of the tile is less likely to be detected as a feature, and it is possible to reduce an edge occurring at the seam between the tiles after restoration.

### Processing Flow of Input Image Data

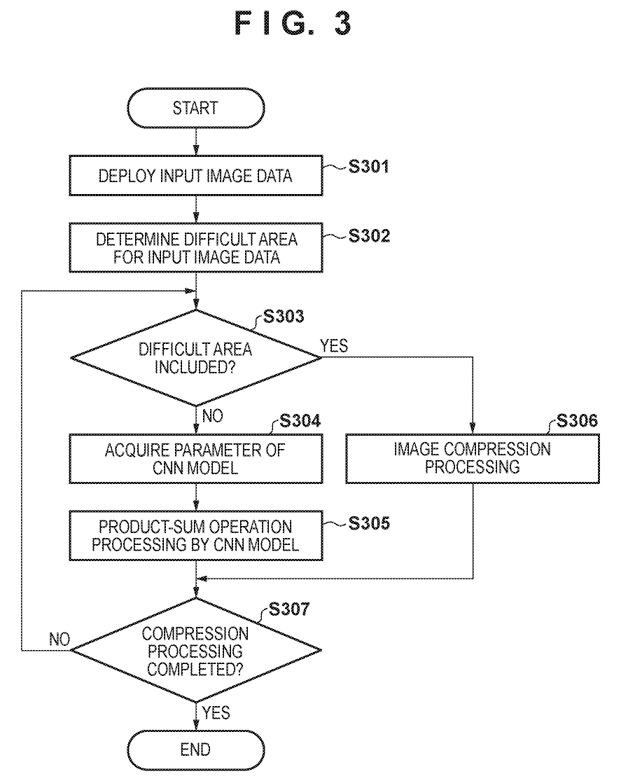

Control of switching between data compression and image compression processing by the CNN model based on the area determination results of the difficult area of the input image data and the other area will be described with reference to FIG. 3. This operation is executed by the CPU 21 reading a command program stored in the external memory 24 or the shared memory 22. Note that the processing described as being performed by the difficult area determination unit 26 is not limited to this, and may be performed by the multiply-accumulate processing unit 23.

In step S301, the CPU 21 deploys (or loads), into the shared memory 22, the input image data stored in the external memory 24. The CPU 21 advances the processing from S301 to S302.

In step S302, the CPU 21 inputs, to the difficult area determination unit 26, the input image data deployed in the shared memory 22. Note that the CPU 21 may input the input image data into the difficult area determination unit 26 in units of the input tile data described above where the input image data is divided. In the difficult area determination unit 26, the area determination neural network or the area determination algorithm performs area determination of the difficult area and the other area on the input image data or the input tile data having been input. This area determination result is stored in the shared memory 22. As illustrated in FIG. 2B, the result of the area determination processing is obtained as area determination data associated with a label indicating whether or not to be a difficult area for each pixel, for example.

Note that in a case where the processing of the difficult area determination unit 26 is executed according to the area determination algorithm not using machine learning, the area determination processing in step S302 may be executed by the CPU 21. On the other hand, in a case where the difficult area determination processing is performed using machine learning such as the CNN, the learned model 122 may be loaded from the external memory into the shared memory 22 while the input image data remains stored in the shared memory 22, and the area determination processing using the learned model 122 may be performed. In this case, the processing may be performed by the multiply-accumulate processing unit 23. The CPU 21 advances the processing from S302 to S303.

In step S303, the CPU 21 divides the input image data into compression target tile data, sequentially targets them as the compression target tile data, and determines whether or not the compression processing target tile data includes a difficult area from the area determination result acquired in S302. In other words, the CPU 21 determines whether to compress the tile data by performing target tile data CNN processing, or to compress the target tile data by processing not using machine learning. If the area determination data corresponding to the target tile data includes a label indicating a difficult area, it is determined that the target tile data includes a difficult area. In that case, the CPU 21 advances the processing to S306 as processing of performing compression processing not using the CNN. Otherwise, the CPU 21 advances the processing to S304 as processing of performing compression processing using the CNN.

In step S304, the CPU 21 inputs the tile data to the multiply-accumulate processing unit 23, and reads and acquires the parameter of the CNN model that performs data compression on the tile data input to the multiply-accumulate processing unit 23, that is, the learned model of the compression processing from, for example, the external memory 24. The parameter of the CNN model that performs data compression is loaded into the shared memory 22 by the CPU 21 and then input to the multiply-accumulate processing unit 23. Note that when the same CNN model as the CNN model for data compression used immediately before is used, in a case where the parameter has been input to the multiply-accumulate processing unit 23, it is not necessary to acquire the parameter, and only the processing target tile data needs to be input. The CPU 21 advances the processing from S304 to S305.

In step S305, the CPU 21 performs the multiply-accumulate processing using the tile data input to the multiply-accumulate processing unit 23 in S304 and the parameter (learned model) of the CNN model that compresses the data input to the multiply-accumulate processing unit 23 in S304. The multiply-accumulate may be executed by the multiply-accumulate processing unit 23. In a case where the multiply-accumulate processing unit 23 is constituted by a sub-processor such as a GPU, for example, the CPU 21 may pass a necessary parameter and the like to the multiply-accumulate processing unit 23 to cause the CNN operation processing to be performed. The multiply-accumulate processing result is stored in the shared memory 22. At this time, a label indicating that the compressed image data does not include a difficult area and is compressed using the CNN is attached. The CPU 21 advances the processing from S305 to S307.

On the other hand, in step S306, the CPU 21 performs image compression processing on the target tile data by a predetermined algorithm. As described above, in S306, lossless compression such as run-length encoding or Huffman encoding, or lossy compression such as discrete cosine transform or fractal compression is executed. Note that the image compression processing is not limited to these examples. Note that the compression algorithm may also be executed using the multiply-accumulate processing unit 23. The image compression processing result is stored in the shared memory 22. At this time, a label indicating that the compressed image data includes a difficult area and is compressed without using the CNN is attached. Note that the adopted compression algorithm may be a predetermined one, or a label indicating the compression algorithm may be attached to the compressed image data. The CPU 21 advances the processing from S306 to S307.

In step S307, the CPU 21 updates the area of the input image data to a tile data range scheduled to be performed next, and determines whether the compression processing of the data of all the tile data with respect to the input image data has been completed. In a case of determining that the CNN processing is not completed, the CPU 21 advances the present processing from S307 to S303. In a case of determining that the CNN processing is completed, the CPU 21 ends the present processing in S307.

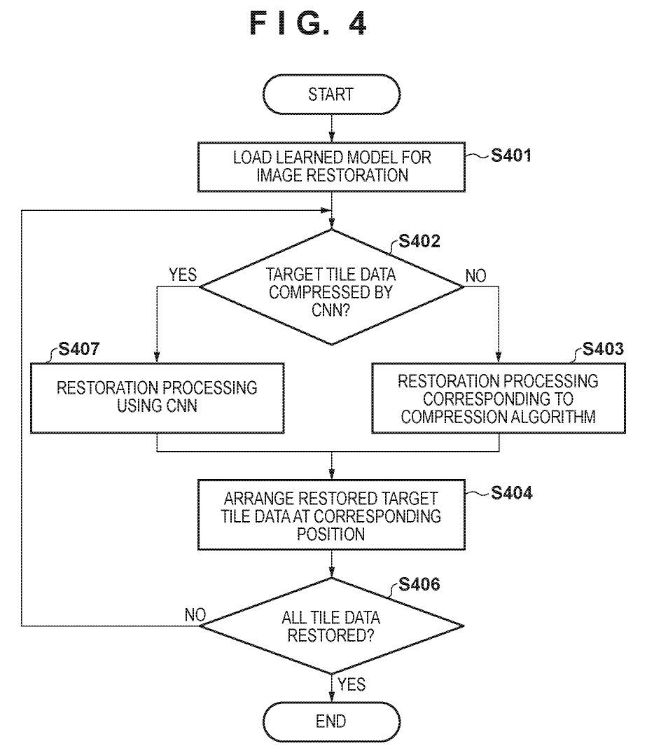

Decoding processing (restoration processing) of compressed image data will be described with reference to FIG. 4. Since the decoding processing is performed in a procedure corresponding to encoding used in the compression processing, the decoding processing corresponding to the compression processing in FIG. 3 is performed in FIG. 4.

First, in S401, the CPU 21 loads a learned model for image decoding from the external memory 24 to the shared memory 22. The learned model for image decoding may be a parameter of the CNN model for image restoration learned at the same time as learning of the parameter of the CNN model for image compression acquired in S304 of FIG. 3.

In S402, the CPU 21 targets the compressed image data that is the restoration target, and determines whether or not a label indicating that the compression by the CNN has been performed is attached to the targeted compressed image data. The compression is performed in units of tiles with the area divided into an area including a difficult area and other areas by the procedure of FIG. 3, and a label indicating whether the image data is compressed by the CNN in S305 or compressed by a compression algorithm not based on the CNN in S306 is given in units of compressed image data. In S402, the label may be referred to. The processing branches to S403 in a case where it is determined that the targeted tile is not compressed by the CNN, and the processing branches to S404 in a case where it is determined that the targeted tile is compressed by the CNN.

In S403, the CPU 21 restores the targeted tile data compressed, by the decoding algorithm corresponding to the image compression processing in S306. The restored tile data is stored in the shared memory 22, for example.

In S404, the CPU 21 arranges the targeted tile data restored in S404 in an area (i.e., the position and range) in the restored image. This arrangement information is stored in association with the compressed image data at the time of compression, and the arrangement information may be referred to in S404.

In S405, the CPU 21 determines whether the restoration processing of the compressed image data of the entire area (i.e., the entire tile data) of the image that is the restoration target has been completed. This determination may also be made with reference to the arrangement information. In a case of determining that the restoration processing of all the tile data has been completed, the CPU 21 ends the processing. In a case of determining that unrestored tile data remains, the processing branches to S402, and the CPU 21 targets the unrestored new tile data to repeat the processing from S402. On the other hand, in a case of determining in S402 that the targeted tile data is compressed by the CNN, the CPU 21 executes in S407 the restoration processing of the tile data compressed by the CNN using the learned model loaded in S401. In step S407, the CPU 21 may cause the multiply-accumulate processing unit 23 to perform the restoration processing. Then, in S406, the CPU 21 arranges the restored tile data at the position and the range in the original image according to the arrangement information. using the CNN.

As described above, the data compression using the CNN and the image compression not using the CNN are switched based on the area determination of the difficult area and the other area of the input image data. This aims to prevent image quality deterioration at the time of image restoration from occurring in the image generation neural network that performs image restoration, and prevents image quality deterioration of the restored image from occurring at the time of high compression of data using the CNN.

### Second Embodiment

In the first embodiment, the image restoration processing of the image generation neural network that performs image restoration adopts a method in which the difficult area determination unit 26 determines an area such as a person’s face, a character string, or a geometric pattern that is generally considered to be difficult. In the second embodiment, a description will be given regarding a method of specializing an image generation neural network that performs image restoration for a predetermined image generation neural network. In the first embodiment, it has been described that the difficult area is calculated by the area determination neural network or the area determination algorithm, but in the second embodiment, the difficult area determination unit 26 determines the difficult area by a method limited to the area determination neural network.

In the second embodiment, the configuration of the image processing apparatus 10 illustrated in FIG. 1A is similar to that of the first embodiment. The same applies to the input image data described in the first embodiment with reference to FIG. 2A. In the first embodiment, in a case where the area determination is performed by machine learning, labeling of the area of the supervisory data may be performed by a human user. In the present embodiment, the area determination is performed by machine learning. Furthermore, in order to generate supervisory data, compression processing using a learned model used for image compression is performed on learning image data, for example, and restoration processing using a learned model used for image restoration is performed to obtain restored image data. Then, a difference for each pixel between the original image data and the restored image data is generated, a label indicating a difficult area is attached to a pixel in which the difference exceeds a threshold, for example, and a label indicating not a difficult area is attached to other pixels. Learning of the area determination processing may be performed using, as input data (learning data), the area data labeled in this manner as supervisory data, together with learning image data. In a case where this learning is performed by the image processing apparatus 10, the learning processing unit 121 is achieved by executing a learning program by the CNN operation processing unit 20.

### Definition of Difficult Area 2

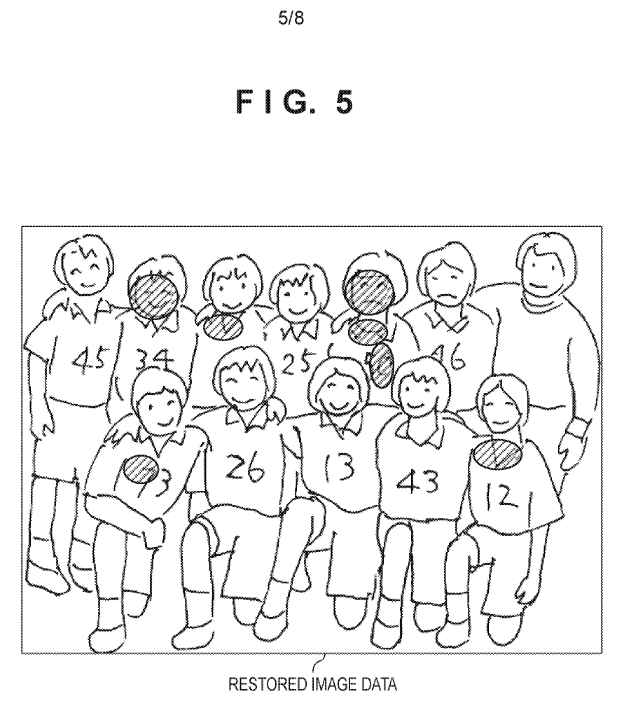

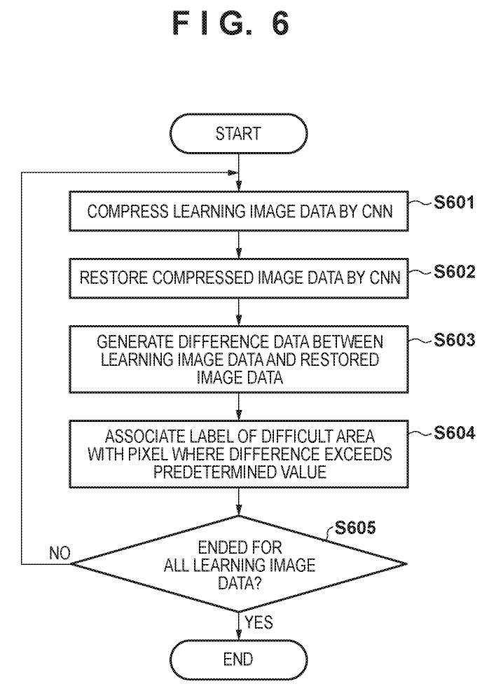

Similarly to the first embodiment, also in the second embodiment, FIG. 2A is a view illustrating an example of input image data to be subjected to determination processing by the difficult area determination unit 26. A result in which this input image data is subjected to image restoration with an output result of the data compression neural network as an input of a predetermined image generation (restoration) neural network is illustrated as restored image data in FIG. 5. The restored image data illustrated in FIG. 5 is compared with the input image data of FIG. 2A. Among them, portions having a large difference from the original image data are the hatched areas surrounded by circle frames in FIG. 5, and these area are defined as a difficult area for a predetermined image generation neural network.

### Determination Method for Difficult Area 2

In the second embodiment, difficult area information for the predetermined image generation neural network is accumulated by using the input image and the restored image data acquired from the predetermined image generation neural network as described above. Learning of the area determination neural network to be executed by the difficult area determination unit 26 is performed in advance using this accumulated information as learning data. Note that similarly to the first embodiment, the area determination neural network may be obtained by performing learning so as to determine the difficult area as "1" and the other area as "0". However, values used at the time of learning of the difficult area and the other area are examples, and the values are not limited to these. In this manner, the determination processing is performed by the difficult area determination unit 26 by the area determination neural network learned in advance, and performing of the area determination of the difficult area as shown in FIG. 4 is achieved. FIG. 6 shows an example of a procedure for creating supervisory data. The processing of FIG. 6 is achieved by executing a program by the CPU 21, but in S601 and S602, the CPU 21 may cause the multiply-accumulate processing unit 23 to execute the processing.

In S601, the CPU 21 compresses the learning image data by the image compression processing using the CNN. The processing of S601 is processing of performing the compression processing by S305 of FIG. 3 over the entire image data, and in a case where the compression is performed in units of tiles as in FIG. 3, all the tiles are compressed by the compression processing using the CNN.

In S602, the CPU 21 restores, by image restoration processing using the CNN, the compressed image data compressed in S601. The processing of S602 is processing of performing the restoration processing by S407 of FIG. 4 over the entire image data, and in a case where the restoration is performed in units of tiles as in FIG. 4, all the tiles are restored by the restoration processing using the CNN. The restored tiles are arranged according to the original learning image data, and learning image data is reproduced. In S603, the CPU 21 generates difference data between the learning image data input in S601 and the restored image data reproduced in S602. The difference data may be a difference for each pixel, for example.

In S604, the CPU 21 compares the difference data generated in S603 with a predetermined value (threshold) set in advance to associate the label of the difficult area with the pixel if the difference exceeds the predetermined value or the difference is the predetermined value or more. This gives area data indicating the difficult area for learning image data. This area data is stored as supervisory data in association with the original learning image data, and is used as learning data for determination of the difficult area. The learning image data and the area data are input to the learning processing unit 121 as the input image data and the supervisory data of FIG. 1C, respectively, and are used for generation of the learned model 122 for area determination.

In S605, the CPU 21 determines whether generation of supervisory data has ended for all the prepared learning image data. In a case where it is determined that the processing has ended, the processing ends. In a case where it is determined that the processing has not ended, the processing branches to S601 with new learning image data as a processing target.

In the above manner, learning data for determining the difficult area is generated using machine learning such as the CNN without manual work by the user.

### Processing Flow of Input Image Data 2

In the second embodiment, similarly to the first embodiment, the multiply-accumulate processing unit 23 and the CPU 21 perform processing of the difficult area and the other area. The flow of the processing shown in FIG. 3 in the first embodiment is also common. Since the description of step S302 is different from that of the first embodiment, the description will be made with reference to FIG. 3. In the second embodiment, step S301 is similar to that in the first embodiment.

In step S302, the CPU 21 inputs, to the difficult area determination unit 26, the input image data deployed in the shared memory 22. Note that the CPU 21 may input the input image data into the difficult area determination unit 26 in units of the input tile data described above where the input image data is divided. In the difficult area determination unit 26, the area determination neural network learned in advance from the input image data and the restored image data performs the area determination of the difficult area and the other area on the input image data or the input tile data having been input. This area determination result is stored in the shared memory 22. At this time, the learned model to be used is a learned model generated using the learning data generated by the procedure of FIG. 6. Thereafter, the CPU 21 advances the processing from S302 to S303.

Note that the processing of S302 may be performed by the multiply-accumulate processing unit 23. In that case, the area determination processing by the CNN may be performed with the processing target image data as an input using the learned model that has learned the area determination processing using the supervisory data obtained by the procedure of FIG. 6.

In the second embodiment, steps S303 to S307 are also similar to those in the first embodiment. As for the restoration processing, the processing of FIG. 4 may be applied similarly to the first embodiment.

As described above, in the second embodiment, the area determination of the difficult area and the other area is performed by the difficult area determination unit 26 by the area determination neural network learned in advance from the input image data and the restored image data. Doing so enables area determination specialized for the difficult area for a predetermined image generation neural network, and aims to prevent image quality deterioration with higher accuracy when using the predetermined image generation neural network.

### Third Embodiment

In the first and second embodiments, the difficult area determination unit 26 performs area determination of the difficult area and the other area of input image data, and then the input tile data having a size matching the input tile size of the CNN model that achieves data compression is created by tile division of the input image data. It is a method of controlling data compression or image compression processing by the CNN model depending on whether or not the input tile data includes a difficult area. In the third embodiment, a description will be given regarding a method of performing data compression and image compression of input image data without switching processing by determining whether or not input image data includes a difficult area for each input tile data.

In the third embodiment, the configuration of the image processing apparatus 10 illustrated in FIG. 1A is similar to that of the first and second embodiments. The same applies to the relationship between the input image data and the difficult area and the determination method of the difficult area, described in the first embodiment with reference to FIGS. 2A and 2B. Note that the relationship of the difficult area and the determination method may be achieved by the method described in the second embodiment.

### Processing of Difficult Area and Other Area 2

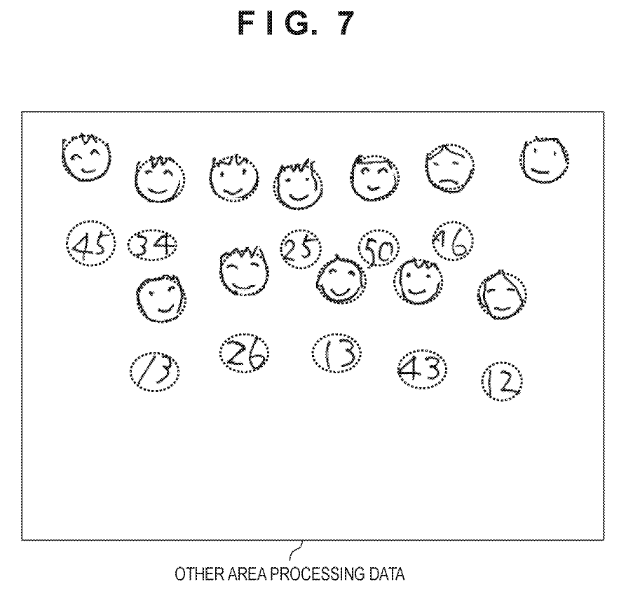

In the third embodiment, similarly to the first and second embodiments, the difficult area determination unit 26 performs the area determination of the difficult area and the other area of the input image data. In a case where the determination result of the difficult area is the result illustrated in FIG. 2B, a processing method of the other area, which is an area other than the difficult area in the input image data, will be described with reference to FIG. 7. In FIG. 7, the difficult area is indicated by an area surrounded by a broken line. On the other hand, the other area is indicated to be overwritten with a constant value. That is, the other area processing data illustrated in FIG. 7 indicates data in which the other area is overwritten and processed with a value represented by "0" or the like and valid data is left only in the difficult area. Note that the value "0" for overwriting the other area is merely an example, and the value is not limited to this, and other values may be used.

In this manner, in the third embodiment, processing data is created targeting the other area from the input image data and the determination result of the difficult area by the difficult area determination unit 26. This is data called other area processing data or simply processed data. The input image data is subjected to compression and restoration using machine learning such as the CNN in the operation processing by the multiply-accumulate processing unit 23 of the CNN operation processing unit 20. On the other hand, the CPU 21 performs image compression processing not using machine learning on the other area processing data created targeting the other area. Note that the operation processing in the multiply-accumulate processing unit 23 and the method of the image compression processing in the CPU 21 are performed similarly to the first and second embodiments.

### Processing Flow of Input Image Data 3

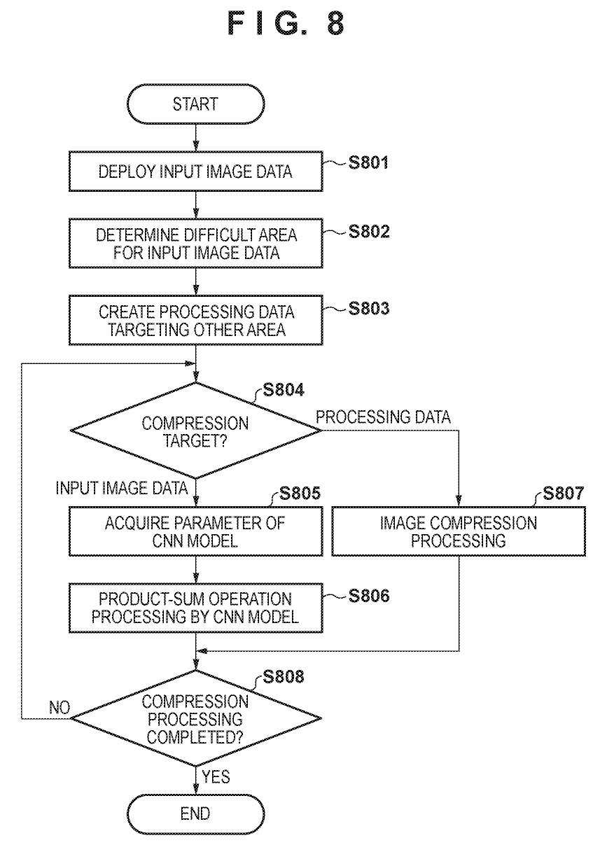

In FIG. 8, control of creating other area processing data and switching between data compression and image compression processing by the CNN model based on the area determination results of the difficult area of the input image data and the other area will be described. This operation is executed by the CPU 21 reading a command program stored in the external memory 24 or the shared memory 22. Note that the processing described as being performed by the difficult area determination unit 26 is not limited to this, and may be performed by the multiply-accumulate processing unit 23. Since S801 to S802 and S804 to S808 may be similar to S301 to S307 of FIG. 3, the description will be simplified. However, in the first embodiment, the image data is compressed and restored in units of tiles, but as described above, it is not necessarily in units of tiles in the present embodiment. Data (also called other area processing data) in which a difficult area is further processed on the original image data of the processing target is generated, and the original image data and the other area processing data are processing targets. However, each may be divided into tile data and compressed and restored in units of tiles.

In step S801, the CPU 21 deploys, into the shared memory 22, the input image data stored in the external memory 24. The CPU 21 advances the present processing from S801 to S802.

In step S802, the CPU 21 inputs, to the difficult area determination unit 26, the input image data deployed in the shared memory 22. In the difficult area determination unit 26, the area determination neural network or the area determination algorithm performs the area determination of the difficult area and the other area on the input image data input. This processing may be similar to the first embodiment or the second embodiment. This area determination result is stored in the shared memory 22. The CPU 21 advances the present processing from S802 to S803.

In step S803, the CPU 21 generates processing data (other area processing data) targeting the other area. At this time, with reference to the input image data and the area determination result, the CPU 21 overwrites and processes, with a predetermined value, the other area, that is, an area that is not the difficult area in the input image data. The other area processing data that is this processing result is stored in the shared memory 22. The CPU 21 advances the present processing from S803 to S804. Note that since the other area processing data is compressed by a compression algorithm not using the CNN, the predetermined value for overwriting the other area that is not a difficult area may be a value at which the compression rate is high, and may be, for example, a value in which all pixels are set to a uniform value. The zero value mentioned above is an example thereof. The other area processing data generated in S803 is associated with the original input image data. Note that in a case where no difficult area is detected from the input image data, it is not necessary to generate other area processing data.

In step S804, the CPU 21 determines which of the original input image data and the other area processing data the processing target is. In a case of determining that it is the input image data, the CPU 21 advances the present processing from S804 to S805. Note that tile data may be input to the multiply-accumulate processing unit 23 similarly to the first and second embodiments. In a case of determining that the processing target is the other area processing data, the CPU 21 advances the processing from S804 to S807.

In step S805, the CPU 21 inputs the input image data, and acquires the parameter of the CNN model that performs data compression on the input image data or the tile data input to the multiply-accumulate processing unit 23. That is, the learned model for image compression processing is acquired. The acquired parameter of the CNN model that performs data compression is deployed in the shared memory 22 by the CPU 21 and then input to the multiply-accumulate processing unit 23. Note that when the same CNN model as the CNN model for performing the data compression used immediately before is used, the present processing needs not be performed in a case where the parameter has been input to the multiply-accumulate processing unit 23. The CPU 21 advances the processing from S805 to S806.

In step S806, the CPU 21 performs the multiply-accumulate processing by using the input image data or the tile data input to the multiply-accumulate processing unit 23 in S804 and the parameter of the CNN model that compresses the data input to the multiply-accumulate processing unit 23 in S805. The multiply-accumulate of the compression processing may be performed by the multiply-accumulate processing unit 23. The multiply-accumulate processing result is stored in the shared memory 22. The CPU 21 advances the processing from S806 to S808.

In step S807, the CPU 21 performs image compression processing on the other area processing data. The compression processing here is achieved by a compression algorithm not using machine learning such as the CNN. The result of the image compression processing is stored in the shared memory 22. The CPU 21 advances the processing from S807 to S808.

In step S808, the CPU 21 determines whether the compression processing of each of the input image data and the other area processing data corresponding thereto has been completed. In a case of determining that the multiply-accumulate processing of all the input image data and the compression processing of the other area processing data have not been completed, the CPU 21 advances the processing from S808 to S804. In a case of determining that it has been completed, the CPU 21 ends the present processing in S808. In a case where the present processing ends, the compressed input image data and the compressed other area processing data are stored in association with each other.

The compressed image data obtained by the above procedure may be restored in the manner shown in FIG. 4. However, although FIG. 4 is premised on restoration in units of tile data, the present embodiment does not have that premise, and therefore "tile data" in FIG. 4 may be read as "data". In the restored input image data, there is a possibility that a difficult area is deteriorated. Therefore, in S404, the input image data may be reproduced by compositing the difficult area included in the restored difficult area processing data and the restored input image data.

As described above, in the third embodiment, the other area processing data is generated from the input image data and the determination result of the difficult area determination unit 26. Then, data compression using machine learning and image compression processing not using machine learning are performed on each of the input image data and the other area processing data. When the compression processing is controlled in units of tile data, there is a concern that the difficult area and the other area are mixed in the tile. However, by switching the processing in each of the input image data and the other area processing data, the processing for each area can be performed with higher accuracy. By preparing other area processing data, it is possible to further improve the image quality after the image restoration processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025225, filed February 19, 2025 which is hereby incorporated by reference herein in its entirety.

What is claimed is:

1. An information processing apparatus comprising: at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning, and
compressing an area including the first area in the input image data by the first compression processing, and compressing a remaining area by the second compression processing.

2. The information processing apparatus according to claim 1, wherein
in determining the first area, an area including at least one of a person’s face, a character string, and a geometric pattern included in the input image data is determined as the first area.

3. The information processing apparatus according to claim 1, wherein
in determining the first area, the first area included in the input image data is determined by machine learning as the first area.

4. The information processing apparatus according to claim 3, wherein
in determining the first area, the first area is determined using a learned model learned using, as supervisory data of the first area, an area in which a difference between the input image data and restored image data in which the input image data is compressed by executing compression processing by the second compression processing and is restored by a restoration means corresponding to the second compression processing exceeds a predetermined value.

5. The information processing apparatus according to claim 1, wherein compression processing is executed in units of tile data in which the input image
data is divided by each of the first compression processing and the second compression processing.

6. The information processing apparatus according to claim 1, wherein the processing further includes
executing first restoration processing of restoring first compressed image data subjected to compression processing by the first compression processing to generate first restored image data, and
executing second restoration processing of restoring second compressed image data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.

7. An information processing apparatus comprising: at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning,
generating processed image data in which an area other than the first area in the input image data is overwritten with a predetermined value, and
compressing the processed image data by the first compression processing and compressing the input image data by the second compression processing.

8. The information processing apparatus according to claim 7, wherein the processing further includes
executing first restoration processing of restoring first compressed image data subjected to compression processing by the first compression processing to generate first restored image data, and
executing second restoration processing of restoring second compressed image
data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.

9. A second information processing apparatus that restores compressed image data compressed by a first information processing apparatus, wherein the first information processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning, and
compressing an area including the first area in the input image data by the first compression processing, and compressing a remaining area by the second compression processing,
the second information processing apparatus includes: at least one memory storing instructions; and
at least one processor that is in communication with the at least one memory and that, when executing the instructions, cooperates with the at least one memory to execute processing, the processing including
executing first restoration processing of restoring first compressed image data subjected to compression processing by the first compression processing to generate first restored image data, and
executing second restoration processing of restoring second compressed image data subjected to compression processing by the second compression processing to generate second restored image data, and
the first compressed image data included in target compressed image data is restored by the first restoration processing and the second compressed image data included in the target compressed image data is restored by the second restoration processing to restore image data by compositing the first restored image data and the second restored image data.

10. A second information processing apparatus that restores compressed image data compressed by a first information processing apparatus, wherein the first information processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning,
generating processed image data in which an area other than the first area in the input image data is overwritten with a predetermined value, and
compressing the processed image data by the first compression processing and compressing the input image data by the second compression processing,
the second information processing apparatus includes: at least one memory storing instructions; and
at least one processor that is in communication with the at least one memory and that, when executing the instructions, cooperates with the at least one memory to execute processing, the processing including
executing first restoration processing of restoring first compressed image data subjected to compression processing by the first compression processing to generate first restored image data, and
executing second restoration processing of restoring second compressed image data subjected to compression processing by the second compression processing to generate second restored image data, and
the first compressed image data included in target compressed image data is
restored by the first restoration processing and the second compressed image data included in the target compressed image data is restored by the second restoration processing to restore image data by compositing the first restored image data and the second restored image data.

11. A non-transitory computer-readable storage medium storing a program that, when loaded on a computer and executed, causes the computer to execute processing, wherein the processing includes
determining, from input image data, a first area that is not a target of image compression processing and image restoration processing by machine learning,
executing first compression processing of compressing image data without machine learning,
executing second compression processing of compressing image data with machine learning, and
compressing an area including the first area in the input image data by the first compression processing, and compressing a remaining area by the second compression processing.

12. A non-transitory computer-readable storage medium storing a program that, when loaded on a computer and executed, causes the computer to execute processing, wherein the processing includes
determining, from input image data, a first area that is not a target of image compression processing and image restoration processing by machine learning,
executing first compression processing of compressing image data without machine learning,
executing second compression processing of compressing image data with machine learning,
generating processed image data in which an area other than the first area in the input image data is overwritten with a predetermined value, and
compressing the processed image data by the first compression processing and compressing the input image data by the second compression processing.

13. A non-transitory computer-readable storage medium storing a program that, when loaded on and executed by a computer that restores compressed image data compressed by a first information processing apparatus, causes the computer to execute processing, wherein
the first information processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning, and
compressing an area including the first area in the input image data by the first compression processing, and compressing a remaining area by the second compression processing,
the processing by the computer includes
executing first restoration processing of restoring first compressed image data subjected to compression processing by the first compression processing to generate first restored image data, and
executing second restoration processing of restoring second compressed image data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.

14. A non-transitory computer-readable storage medium storing a program that, when loaded on a computer that restores compressed image data compressed by a first information processing apparatus and executed, causes the computer to execute processing, wherein
the first information processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning,
generating processed image data in which an area other than the first area in the input image data is overwritten with a predetermined value, and
compressing the processed image data by the first compression processing and compressing the input image data by the second compression processing,
the processing by the computer includes
executing first restoration processing of restoring first compressed image data subjected to compression processing by the first compression processing to generate first restored image data, and
executing second restoration processing of restoring second compressed image data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.

15. An image compression method by an information processing apparatus, the image compression method comprising:
determining, from input image data, a first area that is not a target of image compression processing and image restoration processing by machine learning;
executing first compression processing of compressing image data without machine learning,
executing second compression processing of compressing image data with machine learning; and
compressing an area including the first area in the input image data by the first compression processing, and compressing a remaining area by the second compression processing.

16. An image compression method by an information processing apparatus, the
image compression method comprising:
determining, from input image data, a first area that is not a target of image compression processing and image restoration processing by machine learning;
executing first compression processing of compressing image data without machine learning;
executing second compression processing of compressing image data with machine learning;
generating processed image data in which an area other than the first area in the input image data is overwritten with a predetermined value; and
compressing the processed image data by the first compression processing and compressing the input image data by the second compression processing.

17. An image restoration method by a second information processing apparatus that restores compressed image data compressed by a first information processing apparatus, wherein the first image processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning, and
compressing an area including the first area in the input image data by the first compression processing, and compressing a remaining area by the second compression processing,
the image restoration method includes
executing first restoration processing of restoring first compressed image data subjected to compression processing by the first compression processing to generate first restored image data, and
executing second restoration processing of restoring second compressed image data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.

18. An image restoration method by a second information processing apparatus that restores compressed image data compressed by a first information processing apparatus, wherein the first information processing apparatus includes:
at least one memory storing instructions; and
at least one processor that is in communication with the at least one memory and that, when executing the instructions, cooperates with the at least one memory to execute processing, the processing including
determining, from input image data, a first area that is not a target of image compression processing and image restoration processing by machine learning,
executing first compression processing of compressing image data without machine learning,
executing second compression processing of compressing image data with machine learning,
generating processed image data in which an area other than the first area in the input image data is overwritten with a predetermined value, and
compressing the processed image data by the first compression processing and compressing the input image data by the second compression processing,
the image restoration method includes
executing first restoration processing of restoring first compressed image data subjected to compression processing by the first compression processing to generate first restored image data, and
executing second restoration processing of restoring second compressed image data subjected to compression processing by the second compression processing to generate second restored image data, and
restoring the first compressed image data included in target compressed image data by the first restoration processing and restoring the second compressed image data included in the target compressed image data by the second restoration processing to restore image data by compositing the first restored image data and the second restored image data.
